(19) United States
(12) Patent Application Publication
(10) Pub. No.: US 2026/0067774 A1
(43) Pub. Date: Mar. 5, 2026

(54) L1-L2 Triggered Cell Switch

(71) Applicant: Apple Inc., Cupertino, CA (US)

(72) Inventors: Hong He, Cupertino, CA (US); Dawei Zhang, Saratoga, CA (US); Wei Zeng, San Diego, CA (US); Haitong Sun, Cupertino, CA (US); Chunxuan Ye, San Diego, CA (US); Chunhai Yao, Beijing (CN); Weidong Yang, San Diego, CA (US); Ankit Bhamri, Bad Nauheim (DE)

(21) Appl. No.: 18/726,960

(22) PCT Filed: Sep. 28, 2023
(86) PCT No.: PCT/CN2023/122473

§ 371 Date: Jul. 5, 2024

(51) Int. Cl. H04W 36/08; H04W 36/00; H04W 36/30

(52) U.S. Cl. CPC H04W 36/08; H04W 36/0072; H04W 36/30

(57) ABSTRACT

This disclosure relates to techniques for performing layer 1 and/or layer 2 triggered cell switching in a wireless communication system. One or more transmission configuration indicator (TCI) states may be activated prior to the switch. One or more TCIs may be applied after the switch. Zero or more TCIs may be released or activated. An indication of the completion of the cell switch may be transmitted.

### PRIORITY INFORMATION

This application is a national phase entry of PCT application number PCT/CN2023/122473, entitled “L1-L2 Triggered Cell Switch,” filed Sep. 28, 2023, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for communication using layer 1 and/or layer 2 triggered cell switching in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, CHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for communication using layer 1 and/or layer 2 triggered cell switching in a wireless communication system.

According to one set of embodiments, a method, may comprise: receiving, from a cellular network, a list of candidate secondary cells and performing, at least one measurement of one or more candidate secondary cell of the list of candidate secondary cells, wherein the at least one measurement comprises a layer 1 (L1) or layer 2 (L2) measurement. The method may further comprise reporting the at least one measurement of the one or more candidate secondary cell to the cellular network. The method may further comprise receiving, from the cellular network, a first indication of at least one activated transmission configuration indication (TCI) state for at least one candidate secondary cell of the list of candidate secondary cells. The method may further comprise after receiving the first indication, receiving, from the cellular network, a cell switch command (CSC) signal to switch from a previous secondary cell to a selected secondary cell of the list of candidate secondary cells. The method may further comprise applying a selected TCI state for the selected secondary cell, wherein the selected TCI state is among the at least one activated TCI state.

One set of embodiments may include a method, comprising: performing, at least one measurement of one or more candidate cell of a cellular network, wherein the at least one measurement comprises a layer 1 (L1) or a layer 2 (L2) measurement and reporting the at least one measurement of the one or more candidate cell to the cellular network. The method may further comprise receiving, from the cellular network, a first indication of a plurality of activated transmission configuration indication (TCI) states for at least one candidate cell. The method may further comprise, after receiving the first indication, receiving, from the cellular network, a cell switch command (CSC) signal comprising a second indication of a selected TCI state from the plurality of activated TCI states, to use after a cell switch. The method may further comprise, after the cell switch: applying the selected TCI state to a first candidate cell indicated by the CSC signal; and releasing at least one other activated TCI state of the plurality of activated TCI states.

One set of embodiments may include a method, comprising: performing, at least one measurement of one or more candidate cell of a cellular network, wherein the at least one measurement comprises a layer 1 (L1) or a layer 2 (L2) measurement and reporting the at least one measurement of the one or more candidate cell to the cellular network. The method may further comprise receiving, from the cellular network, a first indication of a plurality of activated transmission configuration indication (TCI) states for at least one candidate cell. The method may further comprise, after receiving the first indication, receiving, from the cellular network, a cell switch command (CSC) signal comprising an indication of a selected TCI state, of the plurality of activated TCI states, to use following a cell switch. The method may further comprise, after the cell switch: selecting a first uplink resource for transmission of a message indicating that the cell switch operation is complete; and transmitting, to the cellular network, the message on the first uplink resource.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings.

FIG. 1 illustrates an example (and simplified) wireless communication system, according to some embodiments.

FIG. 2 illustrates an example base station in communication with an example wireless user equipment (UE) device, according to some embodiments.

FIG. 3 illustrates an example block diagram of a UE, according to some embodiments.

FIG. 4 illustrates an example block diagram of a base station, according to some embodiments.

FIG. 5 is a communication flow diagram illustrating aspects of an example possible method for communication using layer 1 and/or layer 2 triggered cell switching, according to some embodiments.

FIGS. 6-12 illustrate example aspects of various possible approaches to communication using layer 1 and/or layer 2 triggered cell switching, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
PDCCH: Physical Downlink Control Channel
TRP: Transmission-Reception-Point
TCI: Transmission Control Indicator
QCL: Quasi-co-located
DCI: Downlink Control Information
CSI: Channel State Information
CQI: Channel Quality Indicator

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

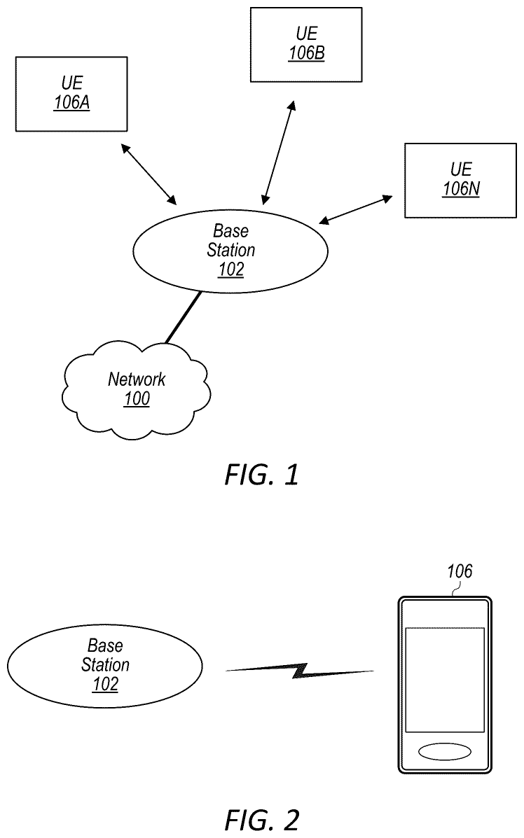

### FIGS. 1 and 2—Example Communication System

FIG. 1 illustrates an example (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the example wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for communication using layer 1 and/or layer 2 triggered cell switching in a wireless communication system, such as according to the various methods described herein. The UE 106 might also or alternatively be configured to communicate using WLAN, BLUETOOTH™ one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an example user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

In some embodiments, the UE 106 may include multiple subscriber identity modules (SIMs, sometimes referred to as SIM cards). In other words, the UE 106 may be a multi-SIM (MUSIM) device, such as a dual-SIM device. Any of the various SIMs may be physical SIMs (e.g., SIM cards) or embedded (e.g., virtual) SIMs. Any combination of physical and/or virtual SIMs may be included. Each SIM may provide various services (e.g., packet switched and/or circuit switched services) to the user. In some embodiments, UE 106 may share common receive (Rx) and/or transmit (Tx) chains for multiple SIMs (e.g., UE 106 may have a dual SIM dual standby architecture). Other architectures are possible. For example, UE 106 may be a dual SIM dual active architecture, may include separate Tx and/or Rx chains for the various SIMs, may include more than two SIMs, etc.

The different identities (e.g., different SIMs) may have different identifiers, e.g., different UE identities (UE IDs). For example, an international mobile subscriber identity (IMSI) may be an identity associated with a SIM (e.g., in a MUSIM device each SIM may have its own IMSI). The IMSI may be unique. Similarly, each SIM may have its own unique international mobile equipment identity (IMEI). Thus, the IMSI and/or IMEI may be examples of possible UE IDs, however other identifiers may be used as UE ID.

The different identities may have the same or different relationships to various public land mobile networks (PLMNs). For example, a first identity may have a first home PLMN, while a second identity may have a different home PLMN. In such cases, one identity may be camped on a home network (e.g., on a cell provided by BS 102) while another identity may be roaming (e.g., while also camped on the same cell provided by BS 102, or a different cell provided by the same or different BS 102). In other circumstances, multiple identities may be concurrently home (e.g., on the same or different cells of the same or different networks) or may be concurrently roaming (e.g., on the same or different cells of the same or different networks). As will be appreciated, numerous combinations are possible. For example, two SIM subscriptions on a MUSIM device may belong to the same equivalent/carrier (e.g., AT&T/AT&T or CMCC/CMCC). As another example possibility, SIM-A may be roaming into SIM-B's network (SIM-A CMCC user roaming into AT&T and SIM-B is also AT&T).

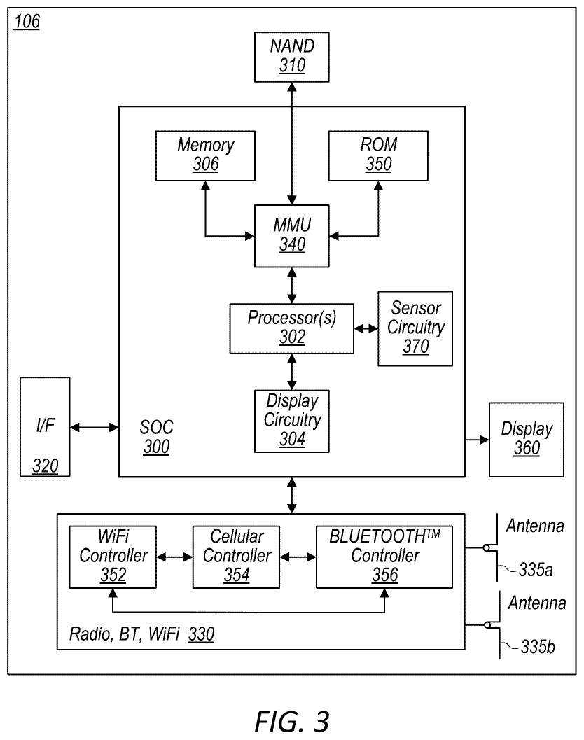

### FIG. 3—Block Diagram of an Example UE Device

FIG. 3 illustrates a block diagram of an example UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for communication using layer 1 and/or layer 2 triggered cell switching in a wireless communication system, such as described further subsequently herein. The processor(s) 302 of the UE device 106 may be configured to implement part or all the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for communication using layer 1 and/or layer 2 triggered cell switching in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

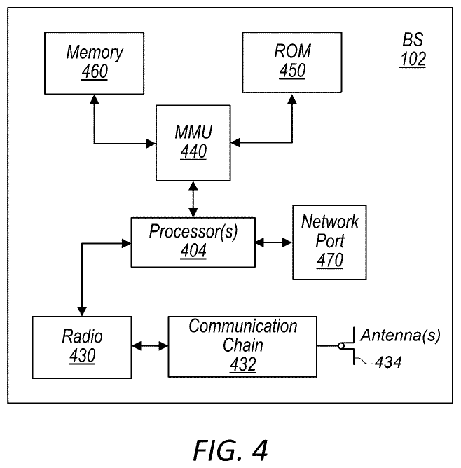

### FIG. 4—Block Diagram of an Example Base Station

FIG. 4 illustrates a block diagram of an example base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Reference Signals and Measurements

A wireless device, such as a user equipment, may be configured to perform a variety of tasks that include the use of reference signals (RSs) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of a CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be provided.

As a detailed example, in the 3GPP NR cellular communication standard, the channel state information fed back (e.g., transmitted via PUCCH or other signaling/channel) from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may transmit uplink control signals to a base station that include an indication of a high CQI value, which may cause the base station to transmit data using a relatively high modulation order and/or a low channel coding rate. As another example, when the downlink channel communication quality between the base station and the UE is determined to be low, the UE may transmit uplink control signals to a base station that include an indication of a low CQI value, which may cause the base station to transmit data using a relatively low modulation order and/or a high channel coding rate.

PMI feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes may be defined (e.g., where R represents the number of layers, Nₜ represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

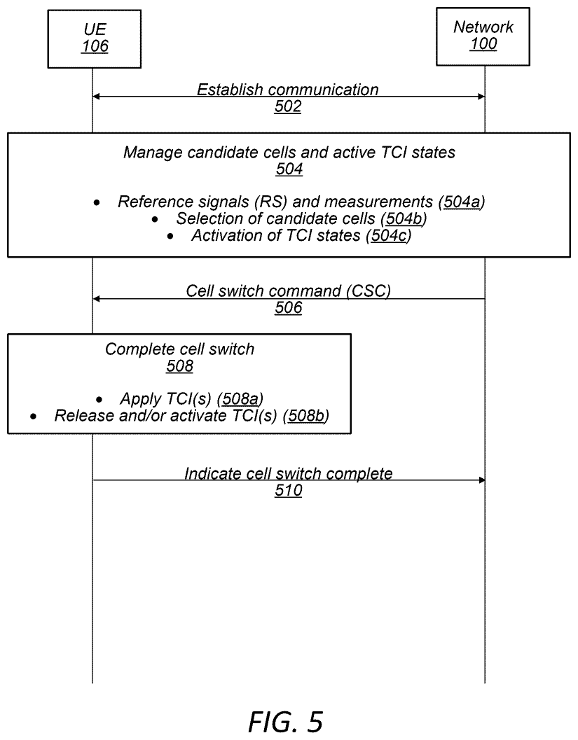

### FIG. 5—L1/L2 Triggered Cell Switching

Transmission to/from a UE and a cell may be directed according to a transmission configuration indication (TCI) state. For example, a TCI state may correspond to an uplink and/or downlink beam. A UE may be configured to use one or more TCI states simultaneously.

A “joint” TCI state may refer to using a same TCI state for uplink (UL) and downlink (DL) communication between a UE and a cell. In a joint TCI mode, one indicated TCI state may be applied to both directions. Alternatively, in a separate TCI mode, a UL TCI state may be indicated separately from a DL TCI state for the same cell.

Some (e.g., new) mobile services that benefit from (or possibly require) low-latency and high reliability performance (e.g., ultra reliable low latency communication (URLLC)) are emerging. While the 5G standard has been designed to address these services from the start, the evolution of 5G New Radio (NR) may strive to enhance the mobility robustness performance for these challenging scenarios. For example, in RAN plenary 94-e Meeting, one Work Item “NR mobility enhancements” was approved with the following objective: layer 1 (L1) enhancements for inter-cell beam management, including L1 measurement and reporting, and beam indication. Further, in a RAN2 #123 meeting in May, the following was agreed to support Carrier Aggregation (CA) based L1 and layer 2 (L2) triggered mobility (LTM) operation in a single Cell Group (CG) in Rel-18:1) LTM supports the following CA scenarios: primary cell (PCell) change by LTM without changing a secondary cell (SCell) (or similarly, changing primary cell group (PCG) by LTM without changing secondary cell group (SCG); and 2) changing SCell or SCG by LTM, without involvement or change of PCell/PCG. LTM may refer to changing between cells and/or cell groups based on L1 and/or L2 measurements.

It will be appreciated that LTM may include changing any combination of primary and/or secondary cells and/or cell groups. For example, a PCell/PCG may be changed without changing SCell/SCG or a SCell/SCG may be changed without changing PCell/PCG. Both primary and secondary cells (or groups) may be changed together.

Further, RAN1 has agreed that TCI state activation of a candidate cell may be received before the reception of beam indication of the candidate cell to reduce latency. In addition, a UE can receive an indication activating a single joint TCI state or a pair of UL/DL TCI state in the cell switch command (CSC) signal.

However, it may be desired to address the following issues to enable CA-based LTM operation: 1) how to indicate TCI state for SCells in a candidate cell list; 2) for a candidate cell, how to handle the activated TCI states other than the indicated TCI state after receiving the cell switch command; and 3) what resource/occasion should be used for a UE, in random access channel (RACH)-less LTM, to send an UL message to let the target cell and/or Distributed Unit (DU) know that this UE is coming and that an UL grant should be provided to the UE, either as a configured grant (CG) or as a dynamic grant (DG). Thus, it may be beneficial to specify techniques for LTM to address these issues. The method of FIG. 5 may be useful in LTM in association with CA scenarios, among various possibilities.

Aspects of the method of FIG. 5 may be implemented by a wireless device, e.g., in conjunction with one or more cells, cellular base stations, and/or transmission/reception points (TRPs), such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

The UE may establish a wireless link with a cellular network (502), according to some embodiments. According to some embodiments, the wireless link may include a cellular link according to 5G NR. For example, the UE may establish a session with an AMF entity of the cellular network by way of one or more base stations (e.g., TRPs and/or gNBs, etc.) that provide radio access to the cellular network. As another possibility, the wireless link may include a cellular link according to LTE. Other types of cellular links are also possible, and the cellular network may also or alternatively operate according to another cellular communication technology (e.g., UMTS, CDMA2000, GSM, etc.), according to various embodiments.

Establishing the wireless link may include establishing a radio resource control (RRC) connection with a serving cellular base station, at least according to some embodiments. Establishing the RRC connection may include configuring various parameters for communication between the UE and the cellular base station, establishing context information for the UE, and/or any of various other possible features, e.g., relating to establishing an air interface for the UE to perform cellular communication with a cellular network associated with the cellular base station. After establishing the RRC connection, the UE may operate in a RRC connected state. In some instances, the RRC connection may also be released (e.g., after a certain period of inactivity with respect to data communication), in which case the UE may operate in a RRC idle state or a RRC inactive state. In some instances, the UE may perform handover (e.g., while in RRC connected mode) or cell re-selection (e.g., while in RRC idle or RRC inactive mode) to a new serving cell, e.g., due to UE mobility, changing wireless medium conditions, and/or for any of various other possible reasons.

At least according to some embodiments, the UE may establish multiple wireless links, e.g., with multiple TRPs of the cellular network, according to a multi-TRP configuration. In such a scenario, the UE may be configured (e.g., via RRC signaling) with one or more TCIs, e.g., which may correspond to various beams that can be used to communicate with the TRPs. Further, it may be the case that one or more configured TCI states may be activated (e.g., by RRC, media access control (MAC) control element (CE), and/or DCI signaling) for the UE at a particular time. For example, multiple TCI states may be activated.

The wireless links may be associated with corresponding control resource set(s) (CORESETs) and/or search space set(s) (SSSs), according to some embodiments. For example, a first TCI state may be associated with a first CORESET and/or SSS, among various possibilities.

At least in some instances, establishing the wireless link(s) may include the UE providing capability information for the UE. Such capability information may include information relating to any of a variety of types of UE capabilities.

At least in some instances, establishing the wireless link(s) may include the UE exchanging configuration information with the network. Among various possibilities, the configuration information may include information related to LTM. For example, the configuration information may include information about reference signals (RS), resources to use for indicating that a cell switch is complete, configuration of TCI lists, selection and/or release of TCI(s), etc.

The configuration information may be exchanged via RRC, among various possibilities.

In some embodiments, 502 may be omitted or may be performed later. For example, other aspects of the method of FIG. 5 (e.g., 504 etc.) may be performed without previously establishing wireless communication with the relevant cell(s) or network.

The network and the UE may perform various actions to manage possible mobility of the UE between various cells of the network (504), according to some embodiments.

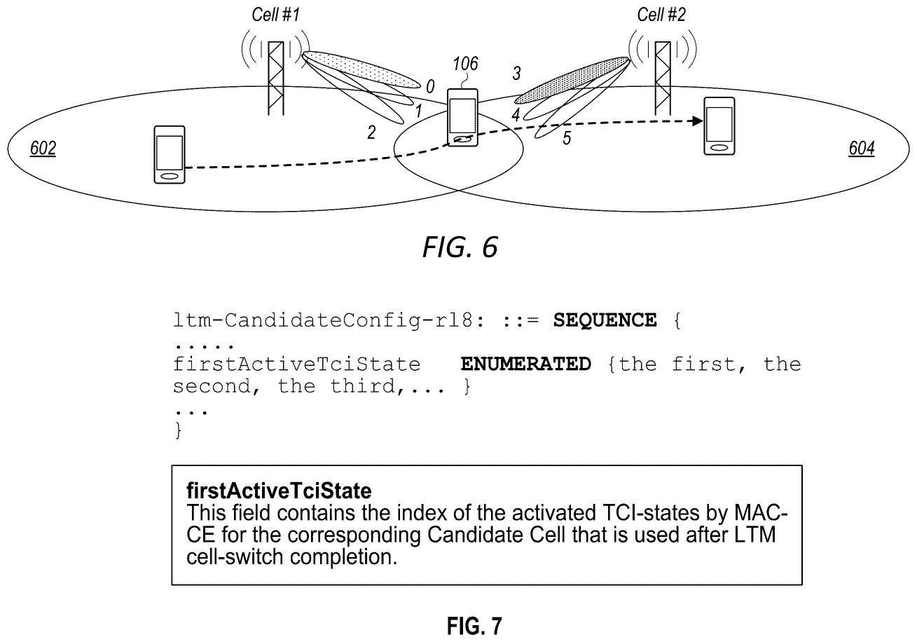

FIG. 6 illustrates an example, in which UE 106 is configured to apply TCI state 0 from cell #1 and TCI state 3 from cell #2, according to some embodiments. Each of these TCI states may be useable for DL communication (and possibly also UL in the case of joint TCI states). As the UE 106 moves from the coverage area 602 of cell #1 to the coverage area 604 of cell #2, the active TCI state(s) may be updated. For example, when UE 106 moves completely into 604 (and no longer is in 602), the UE may switch to cell #2 and the TCI state(s) associated with cell #1 may be released (e.g., deactivated). One or more TCI states associated with cell #2 (e.g., which may be different than TCI state 3) may be applied.

As one possibility for action to manage mobility, the UE and the network (e.g., via any number of cells, BSs, and/or TRPs, etc.) may transmit and/or receive RS and may perform and/or report measurements of the RS (504a), according to some embodiments. As one possibility, the network may transmit downlink RS (e.g., of any of the types discussed herein, among various possibilities) to the UE from one or more serving and/or candidate cells (e.g., PCells and/or SCells). The UE may receive the RS, perform measurements, and report back the measurement results (e.g., in a summarized form or as raw data). For example, the UE may report CSI, CQI, PMI, RI, reference signal received power (RSRP), etc. Similarly, the UE may transmit uplink RS (of any type(s)) and the network may receive those (via any cell(s), etc.) and perform measurements. Either uplink, downlink, or both types of RS and measurements may be used, e.g., at the same or different times and/or frequencies. The measurements may include L1 and/or L2 measurements, e.g., as may be applicable to LTM, among various possibilities.

In the example of FIG. 6, the UE may take measurements of cells #1 and #2 as it moves and may report them to the network. These measurements may be used in the selection of candidate cells (504b), activation of TCI states (504c), and/or commanding a cell switch (506), among various possibilities.

As one possibility for action to manage mobility, the network may select candidate cells for the UE (504b), according to some embodiments. The candidate cells may include candidate PCells and/or candidate SCells. In some embodiments, the network may select candidate cells for the UE based on measurements (e.g., of 504a) and/or other information (e.g., including location or movement data of the UE in relation to the cell(s), etc.).

In some embodiments, the network may (e.g., once, as needed, and/or periodically) provide to the UE one or more list of candidate cells. For example, the network may provide such a list to UE by a dedicated RRC signaling, such as LTMCandidateToAddModList. Other types of signaling (e.g., MAC) or messages may be used to provide such list(s) as desired.

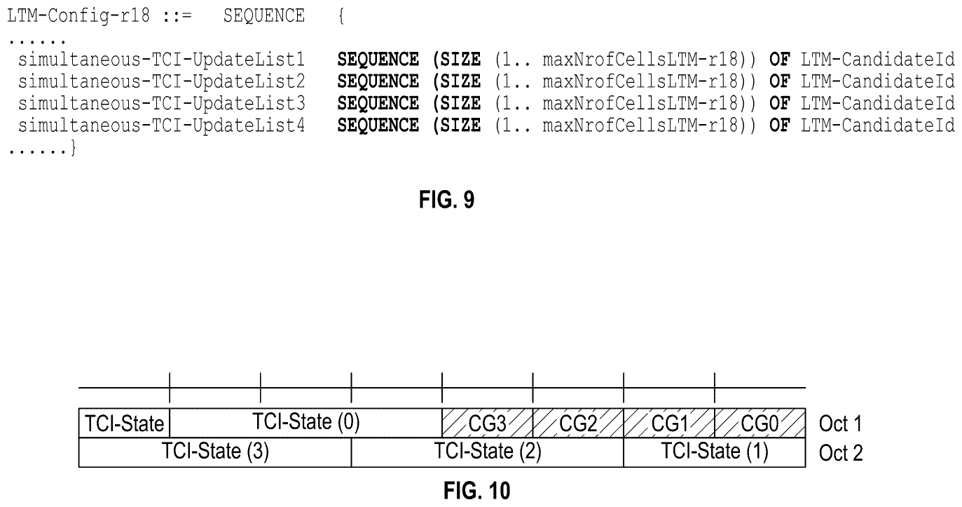

FIG. 9 illustrates one example of candidate cell lists, according to some embodiments. As shown, a UE may be provided with up to four (note: other numbers may be used) cell lists (e.g., by IEs such as the illustrated simultaneous-TCI-UpdateList IEs). The lists may include Special Cell (SpCell) (e.g., a PCell in MCG or a pSCell in SCG) and/or SCells for simultaneous TCI state indication. In some embodiments, the simultaneous-TCI-UpdateList may be provided in the candidate cell list configuration associated with the target cell(s).

Note that the example of simultaneous TCI state indication is discussed further below with respect to 506. Various examples of candidate cell lists may be used without simultaneous TCI state indication.

In the example of FIG. 6, cell #2 may initially be a candidate cell (e.g., added at some time while the UE is in 602). After the UE switches to cell #2, cell #1 may become a candidate cell, according to some embodiments.

As one possibility for action to manage mobility, the network may select one or more TCI states to activate and/or to release (e.g., deactivate) (504c), according to some embodiments. The TCI state(s) may be activated or released for PCells and/or SCells, including serving and/or candidate cells. In some embodiments, the network may select the TCI state(s) for activation and/or release for the UE based on measurements (e.g., of 504a) and/or other information (e.g., including location or movement data of the UE in relation to the cell(s) and/or TCIs, etc.).

In some embodiments, the network may (e.g., once, as needed, and/or periodically) provide to the UE one or more list of active TCI states. For example, the network may provide such a list by a dedicated RRC signaling, such as ltm-CandidateConfig-r18 (e.g., or a similar list by another name such as referring to r19 or a future release, etc.). Other types of signaling (e.g., RRC) or messages may be used to provide such list(s) as desired.

In some embodiments, for a SCell in candidate list, up to one TCI state can be activated by MAC-CE before receiving the cell-switch command (CSC) MAC-CE. Thus, the single MAC-CE activated TCI state may be applied for the SCell after the cell switch completion. In other words, for a candidate SCell, prior to a CSC, exactly one TCI state (e.g., in the case of joint TCI states; potentially 2 TCI states in the case of separate UL and DL TCI states) may be activated, and thus the activated TCI state may be applied following the completion of the cell switch. In some embodiments, this approach may include activating one TCI state (e.g., in the case of joint TCI states; potentially 2 TCI states in the case of separate UL and DL TCI states) per candidate cell prior to the CSC, thus the TCI state corresponding to the target cell for the cell switch may be applied following the cell switch.

In some embodiments, a plurality of TCI states may be activated for one or more candidate SCells. For example, for a SCell in candidate list, more than one TCI state may be activated by MAC-CE before CSC MAC-CE. RRC signaling may be used to indicate which one (e.g., in the case of joint TCI states; potentially 2 TCI states in the case of separate UL and DL TCI states) of the activated TCI states may be used after cell switch completion. FIG. 7 illustrates exemplified ASN.1 code for this approach, according to some embodiments. In some embodiments, eight TCI states may be activated before CSC MAC-CE, but other numbers of activated TCI states may be used as desired. As shown, with in a configuration of a list of candidate SCells (e.g., ltm-CandidateConfig-r18) an information element (e.g., “firstActiveTciState”) may list the active TCI state to be used for each of the candidate cells. For example, the entry “the first” may include an index for the TCI state to be used if a switch is made to the first candidate cell, the entry “the second” may include an index for the TCI state to be used if a switch is made to the second candidate cell, etc. The list of candidate SCells (e.g., ltm-CandidateConfig-r18) may be sent by RRC or other form of signaling. The information element (e.g., “firstActiveTciState”) may be sent to the UE prior to a CSC so that the UE is ready to apply the appropriate TCI state promptly at the time of a cell switch. However, in some embodiments, the information element (e.g., “firstActiveTciState”) may be sent concurrently with or after the CSC. A further example of this approach is summarized in the following table:

| Candidate Scells | | | |
|---|---|---|---|
| list (e.g., index of | activated | | Cell switch |
| cells listed in Itm- | TCI states, | firstAc- | command (CSC) |
| CandidateConfig-r18) | per cell | tiveTciState | signal |
| 1 | a, b, c | a | |
| 2 | d, e, f | e | cell 2 (implying |
| | | | state e) |
| 3 | h, i, j, k, l | j | |

As shown, three candidate SCells may be listed, each associated with multiple activated TCI states. The information element (e.g., “firstActiveTciState”) indicates one of the activated TCI states for each of the candidate cells. The CSC may instruct the UE to switch to cell 2. Accordingly, the UE may apply TCI state “e” following the cell switch.

It will be appreciated that in various embodiments, the mobility management processes of 504 (as well as 506, 508, and 510) may be iterative and/or continuous processes. For example, any of 504a, 504b, and 504c may occur simultaneously or in different orders. Similarly, any of 504a, 504b, and 504c may be repeated multiple times (e.g., prior to and/or after performing 506, 508, and/or 510). Further, any of 504a, 504b, and/or 504c may be omitted, according to some embodiments.

The network may determine that mobility of the UE (and/or other factors) justifies a cell (e.g., and/or cell group) switch and may therefore send a command (e.g., CSC) to the UE (506), according to some embodiments. The CSC command may be a command to perform LTM. The network may determine to send the CSC based on L1 and/or L2 measurements (e.g., as in 504a, and/or other measurements performed by the network and/or UE), among various possibilities. The CSC may be a command to change one or more of PCell, PCG, SCell, and/or SCG. The cell or cell group that the UE uses prior to the switch may be referred to as a source cell and the cell or cell group that the UE uses after the switch may be referred to as a target cell.

In some embodiments, the CSC may comprise a MAC-CE, however other forms of signaling (e.g., DCI) may be used as desired.

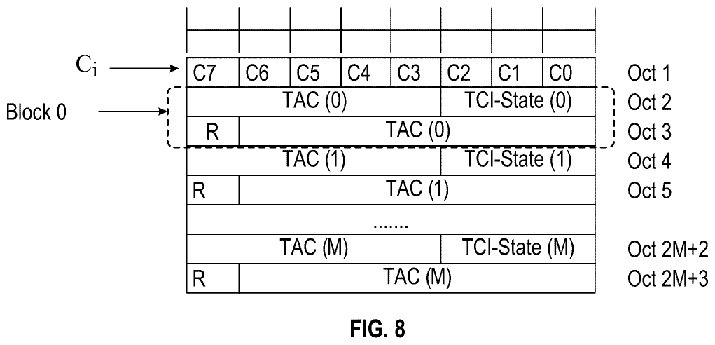

In some embodiments, the CSC may indicate the TCI state to use for a target SCell, and/or SCG. For example, the CSC MAC-CE is further enhanced to include the indicated TCI state for SCells as illustrated in FIG. 8, according to some embodiments. A first field, Cᵢ, may be used to indicate the presence/absence of further configuration information for a candidate cell i. If there is a candidate SCell configured with index i (e.g., in a list of candidate cells such as ltm-CandidateConfig-r18) for LTM cell switch, this field, Cᵢ, may indicate whether a block of information is provided in the CSC for this cell. For example, value ‘1’ may indicate the information is provided and value ‘0’ may indicates no block of information is provided for it. A block of information may be provided for each cell indicated by the field, Cᵢ, to have such a block. The information blocks may be indexed by j so that block j is the block for the jth cell to be indicated as having a block by the field, Cᵢ. In other words, block j may provide a set of information for a LTM-candidate ID ‘j’ where j represents its ordinal position among all the candidate cells with field, Cᵢ, set to the value indicating a block is present (e.g., 1 or true). Thus, the first candidate cell with Cᵢ field set to 1/true may be mapped to the block ‘0’, second with field set to 1/true may be mapped to block ‘l’ and so on. In some embodiments, only one candidate cell may have Cᵢ field set to 1/true. Each block may consist of the following fields for the cell corresponding to block j: TCI state ID, UL TCI state ID (e.g., if operating in a separate TCI state mode; if operating with joint TCIs, this may be omitted as in FIG. 8), and a timing advance command (TAC). Among various possibilities, each TCI ID may be 3 bits and a TAC may be 12 bits. Thus, the UE may use the block corresponding to a target cell to determine which TCI to use for that target cell. It will be appreciated that this approach may be used with respect to PCells or PCGs in addition to or instead of SCells and/or SCGs, according to some embodiments.

In some embodiments, group based TCI state indication may be used. For example, the CSC may indicate the TCI state to use for all candidate cells in a same candidate cell list (e.g., a simultaneous-TCI update list as illustrated in FIG. 9). FIG. 10 illustrates an example of TCI state indication in a CSC MAC-CE applied for all candidate cells in the same candidate cells list configured by a simultaneous-TCI-UpdateList IE, according to some embodiments. As shown, an example new CSC MAC-CE may be as follows. A field, CGᵢ, may be used to indicate whether a block field is associated with a corresponding cell group (CG) list i. For example, if there is a simultaneous-TCI-UpdateList configured with for LTM cell switch, this field, CGᵢ, may indicates if the information is provided. For example, value 0 may indicate that no block field is associated with the CG and value 1 indicates that a block field is associated with the CG (again, note different value schemes may be used). If CGᵢ indicates that a block is present, the block may contain a TCI state field (or two TCI state fields in the case of separate UL and DL TCI states). In the example of FIG. 10, joint TCI is assumed. Accordingly, the field TCI state ID may indicate and activates the joint or DL TCI state for the CG list configured by a simultaneous-TCI-UpdateList IE. In some designs, the field TCI state ID may consists of 3-bits (e.g., assuming up to 8 TCI states are activated before the CSC MAC-CE). In the case of separate UL and DL TCI state operation, a field UL TCI state ID may be included to indicate and activate the UL TCI state for the CG list configured by a simultaneous-TCI-UpdateList IE.

The UE may receive the CSC and complete the cell switch (508), according to some embodiments. The UE may begin communicating with the target cell(s) as serving cell(s) and may cease communicating with the source cell(s) as serving cell(s).

As one possibility, completing the cell switch may include applying one or more TCIs with the target cell(s) (508a), according to some embodiments. For example, applying a TCI state may include using that TCI state to receive and/or transmit to the target cell(s).

In the case that the target cell(s) are SCell(s) and/or SCG(s), the UE may apply indicated TCIs according to any of the approaches discussed above. For example, if only one TCI state (or a pair of states for a separate UL/DL TCI mode) is activated (e.g., in 504 prior to 506), the UE may apply that TCI state (or pair). As another example, if multiple TCI states (or pairs) are activated, the UE may consider any RRC signaling (e.g., as in FIG. 7) indicating which state(s) to use. As another example, if multiple TCI states (or pairs) are activated, the UE may consider any information included in the CSC (e.g., as in FIG. 8 or 10). It will be appreciated that any of these approaches may also or alternatively be applied to target PCell(s) and/or PCG(s), according to some embodiments.

As one possibility, completing the cell switch may include releasing and/or activating one or more active TCIs associated with one or more candidate cell(s) (508b), according to some embodiments. For example, releasing a TCI state may include removing the TCI-state configuration from UE's memory/buffer until it is reconfigured (e.g., in a future instance of 502 or 504, etc.). According to certain aspects of this disclosure, a variety of approaches may be used for considering whether to release any activated TCI states other than any TCI state(s) applied to a target cell (e.g., in 508a). Any combination of the following approaches may be used, among various possibilities.

One approach may be that the UE releases any TCI states (other than any applied state(s)) that were activated before receiving a CSC MAC-CE command. In other words, except for any TCI states applied to the target cell(s), the UE may release any previously activated TCI states. Thus, the UE may release the previously activated TCI states except for the selected/applied TCI state(s).

Another approach may be that RRC (and/or other) signaling may be used to indicate whether to release the other TCI states of a cell or of which TCI state(s) of the cell to release after cell switch completion. Such signaling may be used for each candidate cell individually or for all candidate cells as a group. The signaling may be sent prior to the CSC of 506, concurrently with the CSC of 506, or after the CSC of 506.

In some designs, a UE capability may be introduced to report a maximum total number of activated TCI states (e.g., across serving cells and candidate cells) that the UE can support. The UE may provide the capability information to the network in configuration information (e.g., during 502 and/or any time prior to 510). The UE may provide the capability information via RRC or other signaling. Thus, the network may consider this capability in deciding which (if any) cell(s) to release the activated TCI states or to maintain as activated (e.g., and not release).

Another approach may be candidate cell dependent TCI state release and/or activation. Activated TCI states may be released based on the candidate cell(s) that they are associated with. The UE may maintain the activated TCI states for certain candidate cells under either of the following conditions:
Condition 1: A candidate cell becomes a serving cell after cell switch completion; or
Condition 2: A candidate cell is still in the candidate cell list after cell-switch completion.

For candidate cells that do not meet either of those conditions, the UE may release any activated TCI states associated with the candidate cell. In other words, TCI states that are associated with any candidate cell(s) that either are the target cell (condition 1) or remain as a candidate cell(s) may be retained as activated TCI states and may not be released following the cell switch.

In some embodiments, condition 1 may be implemented as follows. Two TCI states lists (e.g., for a candidate cell) may exist at the UE. One list may be configured outside of candidate cell configuration (e.g., outside of LTM-Candidate-r18 IE) and may be referred to as ‘TCI state list #1’. The other list may be configured in the candidate cell configuration (e.g., inside of LTM-Candidate-r18 IE) and may be referred to as ‘TCI state list #2’. In other words, TCI state list #1 may be known by a UE before receiving cell-switch command, e.g., because it is provided outside of candidate cell configuration and used for TCI-state activation. In contrast, TCI state list #2 may not be known by the UE before receiving cell switch command and therefore may not be used for earlier TCI-state activation before cell switch command. Both TCI-state list #1 and TCI-state list #2 may be known by UE after the cell switch procedure. It will be appreciated that these labels are examples.

In some embodiments, according to a first option for condition 1, the UE may expect that TCI state list #1 is the same as or a subset of TCI state list #2. In these embodiments, any TCI state included on TCI state list #1 for the target cell (e.g., a serving cell following the cell switch according to condition 1) may be maintained as an active TCI state following the cell switch.

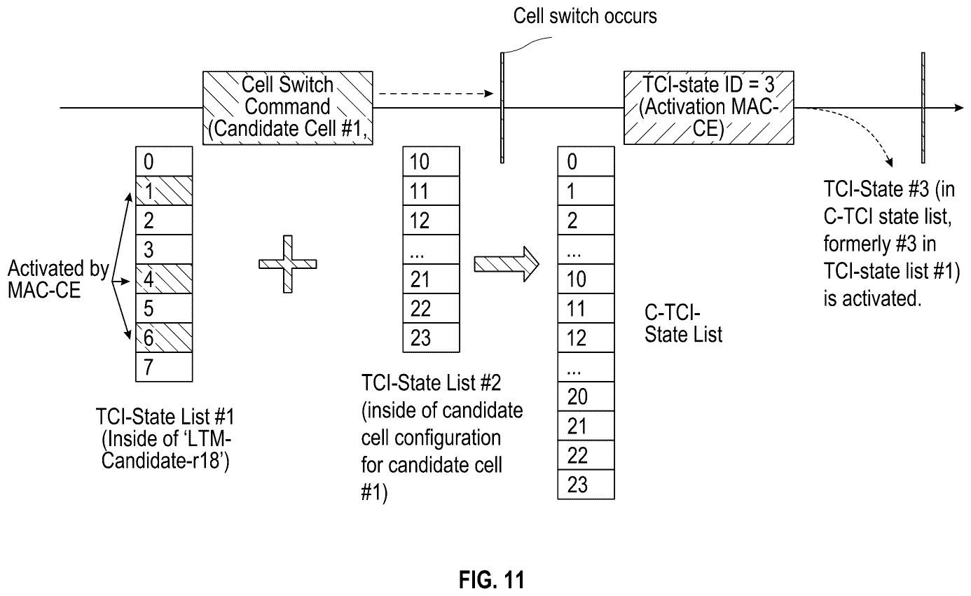

In some embodiments, according to a second option for condition 1, the UE (e.g., and the network) may perform TCI state list concatenation after cell switch. FIG. 11 illustrates an example of this concatenation and resulting activation, according to some embodiments. The process may proceed as follows.

Step-1: The TCI state list #1 and TCI state list #2 may be independently configured without any restriction. For example, there may be no requirement that list 1 is a subset of list 2. The configuration may be done by RRC signaling (or other signaling) during 502 or 504, or any time prior to completion of 508.

Step-2: After the UE has switched to the target candidate cell(s), the UE may perform the TCI states concatenation operation by sequentially concatenating the two TCI state lists. The order of TCI states concatenation operation may be determined according to a wireless standard such as NR or provided/negotiated in configuration information. For example, the concatenation may start from the TCI state list #1 and then TCI state list #2. The concatenated TCI state list may be referred to as ‘C-TCI state List’.

Step-3: When the network transmits and the UE receives a unified TCI states activation/deactivation MAC-CE, the ‘TCI state ID’ field may refer to the TCI state ID in the new C-TCI state List. Thus, the network may indicate, via this MAC-CE (note: other signaling such as DCI may be used if desired), which TCI states are to be activated (e.g., and/or released). This signaling may be concurrent with 506 or at any later time, according to some embodiments.

Regardless of which option is implemented for condition 1, any TCI state associated with a candidate cell that does not meet either condition 1 or condition 2 may be released after the cell switch. For example, any TCI state associated with a cell that is no longer a candidate cell and is not a serving cell may be released.

It will be appreciated that the network may perform equivalent actions to 508, including 508a and/or 508b, according to some embodiments. For example, the network may determine which TCI state(s) to apply and which to release, etc.

It will be appreciated that the actions of 508 (e.g., 508a and/or 508b, etc.) may be omitted, according to some embodiments.

The UE may transmit, and the network may receive, a message indicating that the cell switch is complete (510), according to some embodiments. The message may be transmitted to the target cell(s) or any serving cell. The message may be an RRC message such as RRCReconfigurationComplete, among various possibilities.

The UE and network (e.g., acting independently in parallel) may determine resources for the message. For example, according to certain aspects of this disclosure, when configured grant (CG) physical uplink shared channel (PUSCH) (CG-PUSCH) is used for LTM operation (which may include RACH-less handover), a variety of approaches may be considered to determine the resources (e.g., corresponding CG-PUSCH occasion) for UL transmission of the message indicating that the cell switch is complete).

As one possibility, sequential-mapping between actually-transmitted SSB (or other RS) resources and (e.g., RRC-configured) CG-PUSCH occasions may be used to determine the resources. In other words, the resource may be selected based on a relation of the selected TCI state and uplink resources. For example, the [x*N+K]^{th} CG-PUSCH occasion, corresponding to the Kth transmitted SSB, where:

$$x = 0 , 1 , .. , X - 1 ;$$

K is an integer (e.g., K=1, 2, . . . ); and
N is the number of actual transmitted SSBs in a time period. For example, N may be determined according to ssb-PositionsInBurst which may be reported in system information such as SIB1. For example, after the cell-switch operation, the UE shall use the earliest CG-PUSCH occasion that is associated with the SSB resource that is configured as quasi co-location (QCL) source RS for the selected TCI state (e.g., a TCI state indicated by a CSC MAC-CE). In other words, the UE may determine the UL or joint TCI state for the target cell. Then, the UE may determine a SSB resource that is QCL for that TCI state. The UE may use the earliest CG-PUSCH for the determined SSB. In other words, an earliest configured grant (CG) physical uplink shared channel (PUSCH) (CG-PUSCH) for the SSB QCL with the selected TCI state may be used.

In some embodiments, if a Tracking RS (TRS) is configured as the QCL source RS for the TCI state in the CSC MAC-CE, then the SSB that is configured as QCL source RS of the TRS may be used to map the CG-PUSCH. In other words, the UE may determine the UL or joint TCI state for the target cell. Then, the UE may determine a SSB resource that is QCL for the TRS that TCI state. The UE may use the earliest CG-PUSCH for the determined SSB.

As another possibility, an earliest CG-PUSCH associated with the active TCI state for the target cell may be used to transmit the message. In other words, once the CSC operation is completed at the UE, the TCI state indicated in the MAC-CE may be used at the earliest CG-PUSCH transmission. In other words, an earliest configured grant (CG) physical uplink shared channel (PUSCH) (CG-PUSCH) associated with the selected TCI state may be used.

In some designs, for either of the possibilities discussed above, in order to minimize the cell switch latency, the UE may start monitoring the RRC-configured search space sets for a potential dynamic UL grant from the target cell. If such a dynamic grant occurs, the granted resource(s) may be used for the message indicating that the cell switch is complete (e.g., a first UL message such as RRCReconfigurationComplete). Thus, the transmission may occur before the first CG-PUSCH occasion. In some embodiments, if a dynamic grant occurs and is used for the indication, the first CG-PUSCH may not be used for the indication (e.g., CG-PUSCH may be omitted if the dynamic UL grant is detected). In some embodiments, if a dynamic grant (DG) occurs and is used for the indication, the UL message with the indication (e.g., RRCReconfigurationComplete) may be repeatedly transmitted using the first CG-PUSCH occasion, although it is transmitted using DG-PUSCH earlier.

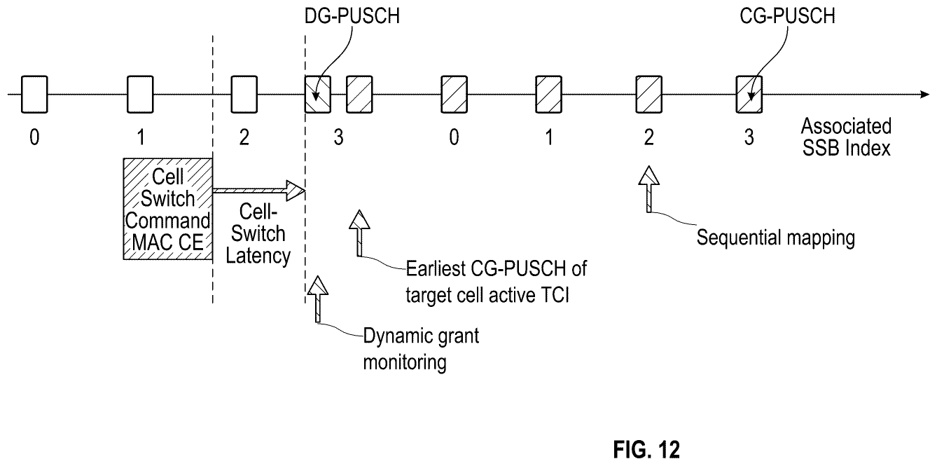

FIG. 12 provides examples to depict alternatives of CG-PUSCH occasion determination assuming 4 SSBs (indexed 0-3, as shown), according to some embodiments. The example of FIG. 12 assumes that the QCL source RS associated with TCI state indicated by CSC MAC is SSB #2. As shown, the CSC may occur between SSBs 1 and 2 and the cell switch may occur between SSBs 2 and 3.

According to the sequential mapping approach discussed above, the determined resource may be the first CG-PUSCH occasion that is associated with the SSB #2. In this example, this approach may result in the largest latency.

The approach of using the earliest CG-PUSCH associated with the active TCI state for the target cell may result in determining a resource at the time of SSB 3. This approach may reduce the latency, but may rely on coordination/notification between source cell (or DU) and target cell (or DU) on the switching beam for CG-PUSCH reception.

In the case that the UE immediately monitors the appropriate (e.g., RRC-configured) search space set for DGs, it is possible that the latency may be minimized.

Thus, at least according to some embodiments, the method of FIG. 5 may be used to provide a framework according to which a UE and network may perform LTM, and thus to assist the network to effectively and efficiently schedule and perform wireless communications with the UE, at least in some instances.

As noted above, the order shown in FIG. 5 is only one example. For instance, it will be appreciated that 504a-504c may occur in any order and/or at the same or overlapping times. Similarly, 508a-508b may be concurrent or occur in any sequence. Further, 510 may occur before, after, or concurrently with 508. Numerous other variations and examples are possible.

Similarly, any of these steps may be repeated any number of times (e.g., as a UE moves, etc.).

It will be appreciated that while various of the examples and figures discussed above may be presented in terms of single TCI states applied to a cell (e.g., a joint TCI state used for both uplink and downlink communication between a UE and a cell), these are examples. The techniques disclosed herein may similarly be applied to separate TCI states (e.g., a DL TCI state and a potentially different UL TCI state used for communication between a UE and a cell). Thus, any of the embodiments and examples herein may be adjusted to incorporate such separate TCI states.

In one set of embodiments, a method may comprise: receiving, from a cellular network, a list of candidate secondary cells; performing, at least one measurement of one or more candidate secondary cell of the list of candidate secondary cells, wherein the at least one measurement comprises a layer 1 (L1) or layer 2 (L2) measurement; reporting the at least one measurement of the one or more candidate secondary cell to the cellular network; receiving, from the cellular network, a first indication of at least one activated transmission configuration indication (TCI) state for at least one candidate secondary cell of the list of candidate secondary cells; after receiving the first indication, receiving, from the cellular network, a cell switch command (CSC) signal to switch from a previous secondary cell to a selected secondary cell of the list of candidate secondary cells; and applying a selected TCI state for the selected secondary cell, wherein the selected TCI state is among the at least one activated TCI state.

In some embodiments, the list of candidate secondary cells is configured by an LTMCandidateToAddModList Information Element (IE) in Radio Resource Control (RRC) signaling.

In some embodiments, the at least one activated TCI state includes only the selected TCI state.

In some embodiments, the at least one activated TCI state includes a plurality of activated TCI states.

In some embodiments, the first indication comprises a Medium Access Control (MAC) Control Element (CE); and the method further comprises: receiving, from the cellular network, a second indication of respective TCI states of the plurality of activated TCI states for respective candidate secondary cells of the list of candidate secondary cells.

In some embodiments, the selected TCI state is indicated by the second indication for the selected secondary cell.

In some embodiments, the second indication is provided by radio resource control (RRC) signaling.

In some embodiments, the at least one activated TCI state includes a plurality of activated TCI states; the first indication comprises a first Medium Access Control (MAC) Control Element (CE); the CSC signal comprises a second MAC-CE; and the second MAC-CE comprises, for at least one respective candidate secondary cell of the list of candidate secondary cells, a respective indication of whether a respective information block for the respective candidate secondary cell is included in the second MAC-CE, wherein the respective information block comprises an indication of a selected TCI state for the respective candidate secondary cell.

In some embodiments, the respective information block in the second MAC-CE comprises an indication of a timing advance command for the respective candidate secondary cell.

In some embodiments, the at least one activated TCI state includes a plurality of activated TCI states; the first indication comprises a first Medium Access Control (MAC) Control Element (CE); and the method further comprises: receiving, from the cellular network, a second indication of one or more cell group lists, wherein each cell group list comprises one or more candidate secondary cells; receiving, from the cellular network, a third indication of a first TCI state of the plurality of activated TCI states for a first cell group list; and applying the first TCI state to all cells of the first cell group list.

In some embodiments, at least one of the one of more cell group lists comprises a candidate primary cell.

In some embodiments, the first TCI state is the selected TCI state.

In one set of embodiments, a method can comprise: performing, at least one measurement of one or more candidate cell of a cellular network, wherein the at least one measurement comprises a layer 1 (L1) or a layer 2 (L2) measurement; reporting the at least one measurement of the one or more candidate cell to the cellular network; receiving, from the cellular network, a first indication of a plurality of activated transmission configuration indication (TCI) states for at least one candidate cell; and after receiving the first indication, receiving, from the cellular network, a cell switch command (CSC) signal comprising a second indication of a selected TCI state from the plurality of activated TCI states, to use after a cell switch; and after the cell switch: applying the selected TCI state to a first candidate cell indicated by the CSC signal; and releasing at least one other activated TCI state of the plurality of activated TCI states.

In some embodiments, the CSC signal comprises a Medium Access Control (MAC) Control Element (CE).

In some embodiments, said releasing at least one other activated TCI state comprises releasing the TCI states of the plurality of activated TCI states except the selected TCI state.

In some embodiments, the method further comprises receiving, from the cellular network, a third indication that indicates for which candidate cell the plurality of activated TCI states are to be released by the UE.

In some embodiments, the third indication comprises Radio Resource Control (RRC) signaling.

In some embodiments, said releasing at least one other activated TCI state comprises a candidate cell dependent TCI state release.

In some embodiments, a condition of the candidate cell dependent TCI state release comprises that a TCI state associated with a candidate cell that becomes a serving cell is not released.

In some embodiments, the method further comprising receiving two TCI state lists for a candidate cell from the cellular network.

In some embodiments, a first TCI state list of the two TCI state lists is a subset of or the same as a second TCI state list of the two TCI state lists.

In some embodiments, further comprising concatenating the two TCI state lists to create a concatenated TCI state list after the cell switch.

In some embodiments, further comprising receiving, from the cellular network, a third indication activating at least one of the plurality of TCI states in the concatenated TCI-state list.

In some embodiments, the third indication comprises a unified TCI states activation/deactivation MAC-CE.

In some embodiments, the third indication refers to the concatenated TCI state list.

In some embodiments, a condition of the candidate cell dependent TCI state release comprises that a TCI state associated with a candidate cell that remains a candidate cell after the cell switch is not released.

In one set of embodiments a method comprises: performing, at least one measurement of one or more candidate cell of a cellular network, wherein the at least one measurement comprises a layer 1 (L1) or a layer 2 (L2) measurement; reporting the at least one measurement of the one or more candidate cell to the cellular network; receiving, from the cellular network, a first indication of a plurality of activated transmission configuration indication (TCI) states for at least one candidate cell; after receiving the first indication, receiving, from the cellular network, a cell switch command (CSC) signal comprising an indication of a selected TCI state, of the plurality of activated TCI states, to use following a cell switch; and after the cell switch: selecting a first uplink resource for transmission of a message indicating that the cell switch operation is complete; and transmitting, to the cellular network, the message on the first uplink resource.

In some embodiments, said selecting the first uplink resource is based on a relation of the selected TCI state and uplink resources.

In some embodiments, said selecting the first uplink resource comprises: determining a first synchronization signal block (SSB) that is configured as quasi co-location (QCL) source RS for the selected TCI; and selecting an earliest configured grant (CG) physical uplink shared channel (PUSCH) (CG-PUSCH) associated with the first SSB.

In some embodiments, the first uplink resource comprises an earliest configured grant (CG) physical uplink shared channel (PUSCH) (CG-PUSCH) after the cell switch; and the selected TCI state is used for transmitting the first uplink resource transmission.

In some embodiments, said selecting the first uplink resource comprises: monitoring for dynamic grants after the cell switch, wherein the first uplink resource is scheduled by a dynamic grant signal.

In some embodiments, said monitoring is of a configured search space set for a target cell of the cell switch.

In one set of embodiments, a method, comprises: transmitting, to a user equipment (UE), a list of candidate secondary cells; receiving, from the UE, reporting of at least one measurement of one or more candidate secondary cell of the list of candidate secondary cells, wherein the at least one measurement comprises a layer 1 (L1) or layer 2 (L2) measurement; transmitting, to the UE, a first indication of at least one activated transmission configuration indication (TCI) state for at least one candidate secondary cell of the list of candidate secondary cells; after transmitting the first indication, transmitting, to the UE, a cell switch command (CSC) signal to switch from a previous secondary cell to a selected secondary cell of the list of candidate secondary cells; and applying a selected TCI state for communication between the UE and the selected secondary cell, wherein the selected TCI state is among the at least one activated TCI state.

In some embodiments, the list of candidate secondary cells is configured by an LTMCandidateToAddModList Information Element (IE) in Radio Resource Control (RRC) signaling.

In some embodiments, the at least one activated TCI state includes only the selected TCI state.

In some embodiments, the at least one activated TCI state includes a plurality of activated TCI states; the first indication comprises a Medium Access Control (MAC) Control Element (CE); and the method further comprises: transmitting, to the UE, a second indication of respective TCI states of the plurality of activated TCI states for respective candidate secondary cells of the list of candidate secondary cells; and the selected TCI state is indicated by the second indication for the selected secondary cell.

In some embodiments, the second indication is provided by radio resource control (RRC) signaling.

In some embodiments, the at least one activated TCI state includes a plurality of activated TCI states; the first indication comprises a first Medium Access Control (MAC) Control Element (CE); the CSC signal comprises a second MAC-CE; and the second MAC-CE comprises, for at least one respective candidate secondary cell of the list of candidate secondary cells, a respective indication of whether a respective information block for the respective candidate secondary cell is included in the second MAC-CE, wherein the respective information block comprises an indication of a selected TCI state for the respective candidate secondary cell.

In some embodiments, the respective information block in the second MAC-CE comprises an indication of a timing advance command for the respective candidate secondary cell.

In some embodiments, the at least one activated TCI state includes a plurality of activated TCI states; the first indication comprises a first Medium Access Control (MAC) Control Element (CE); and the method further comprises: transmitting, to the UE, a second indication of one or more cell group lists, wherein each cell group list comprises one or more candidate secondary cells; transmitting, to the UE, a third indication of a first TCI state of the plurality of activated TCI states for a first cell group list; and applying the first TCI state to all cells of the first cell group list.

In some embodiments, at least one of the one of more cell group lists comprises a candidate primary cell.

In some embodiments, the first TCI state is the selected TCI state.

In one set of embodiments, a method, comprises: receiving, from a user equipment (UE), reporting of at least one measurement of one or more candidate cell of a cellular network, wherein the at least one measurement comprises a layer 1 (L1) or a layer 2 (L2) measurement; transmitting, to the UE, a first indication of a plurality of activated transmission configuration indication (TCI) states for at least one candidate cell; and after transmitting the first indication, transmitting, to the UE, a cell switch command (CSC) signal comprising a second indication of a selected TCI state from the plurality of activated TCI states, to use after a cell switch; and after the cell switch: applying the selected TCI state for communication between the UE and a first candidate cell indicated by the CSC signal; and determining that the UE is permitted to release at least one other activated TCI state of the plurality of activated TCI states.

In some embodiments, the CSC signal comprises a Medium Access Control (MAC) Control Element (CE).

In some embodiments, to release at least one other activated TCI state comprises releasing the TCI states of the plurality of activated TCI states except the selected TCI state.

In some embodiments, the method further comprising transmitting, to the UE, a third indication that indicates for which candidate cell the plurality of activated TCI states are to be released by the UE.

In some embodiments, the third indication comprises Radio Resource Control (RRC) signaling.

In some embodiments, to release at least one other activated TCI state comprises a candidate cell dependent TCI state release.

In some embodiments, a condition of the candidate cell dependent TCI state release comprises that a TCI state associated with a candidate cell that becomes a serving cell is not released.

In some embodiments, the method further comprising transmitting, to the UE, two TCI state lists for a candidate cell.

In some embodiments, a first TCI state list of the two TCI state lists is a subset of or the same as a second TCI state list of the two TCI state lists.

In some embodiments, the method further comprising concatenating the two TCI state lists to create a concatenated TCI state list after the cell switch.

In some embodiments, the method further comprising transmitting, to the UE, a third indication activating at least one of the plurality of TCI states in the concatenated TCI-state list.

In some embodiments, the third indication comprises a unified TCI states activation/deactivation MAC-CE.

In some embodiments, the third indication refers to the concatenated TCI state list.

In some embodiments, a condition of the candidate cell dependent TCI state release comprises that a TCI state associated with a candidate cell that remains a candidate cell after the cell switch is not released.

In one set of embodiments, a method may comprise: receiving, from a user equipment (UE), reporting of at least one measurement of one or more candidate cell of a cellular network, wherein the at least one measurement comprises a layer 1 (L1) or a layer 2 (L2) measurement; transmitting, to the UE, a first indication of a plurality of activated transmission configuration indication (TCI) states for at least one candidate cell; after transmitting the first indication, transmitting, to the UE, a cell switch command (CSC) signal comprising an indication of a selected TCI state, of the plurality of activated TCI states, to use following a cell switch; and after the cell switch: determining a first uplink resource for reception of a message indicating that the cell switch operation is complete; and receiving, from the UE, the message on the first uplink resource.

In some embodiments, said determining the first uplink resource is based on a relation of the selected TCI state and uplink resources.

In some embodiments, said determining the first uplink resource comprises: determining a first synchronization signal block (SSB) that is configured as quasi co-location (QCL) source RS for the selected TCI; and determining an earliest configured grant (CG) physical uplink shared channel (PUSCH) (CG-PUSCH) associated with the first SSB.

In some embodiments, the first uplink resource comprises an earliest configured grant (CG) physical uplink shared channel (PUSCH) (CG-PUSCH) after the cell switch; and the selected TCI state is used for receiving the first uplink resource transmission.

In some embodiments, the first uplink resource is scheduled by a dynamic grant signal.

In some embodiments, the dynamic grant is transmitted in a configured search space set for a target cell of the cell switch.

A further example embodiment may include a method, comprising: performing, by a wireless device, any or all parts of the preceding examples.

Another example embodiment may include a device, comprising: an antenna; a radio coupled to the antenna; and a processing element operably coupled to the radio, wherein the device is configured to implement any or all parts of the preceding examples.

A further example set of embodiments may include a non-transitory computer accessible memory medium comprising program instructions which, when executed at a device, cause the device to implement any or all parts of any of the preceding examples.

A still further example set of embodiments may include a computer program comprising instructions for performing any or all parts of any of the preceding examples.

Yet another example set of embodiments may include an apparatus comprising means for performing any or all of the elements of any of the preceding examples.

Still another example set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station or cellular network, by interpreting each message/signal X received by the UE in the downlink as message/signal X transmitted by the base station or cellular network, and each message/signal Y transmitted in the uplink by the UE as a message/signal Y received by the base station or cellular network.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving, from a cellular network, a list of candidate secondary cells;
performing, at least one measurement of one or more candidate secondary cell of the list of candidate secondary cells, wherein the at least one measurement comprises a layer 1 (L1) or layer 2 (L2) measurement;
reporting the at least one measurement of the one or more candidate secondary cell to the cellular network;
receiving, from the cellular network, a first indication of at least one activated transmission configuration indication (TCI) state for at least one candidate secondary cell of the list of candidate secondary cells;
after receiving the first indication, receiving, from the cellular network, a cell switch command (CSC) signal to switch from a previous secondary cell to a selected secondary cell of the list of candidate secondary cells; and
applying a selected TCI state for the selected secondary cell, wherein the selected TCI state is among the at least one activated TCI state.

2. The method of claim 1, wherein the list of candidate secondary cells is configured by an LTMCandidateToAddModList Information Element (IE) in Radio Resource Control (RRC) signaling.

3. The method of claim 1, wherein the at least one activated TCI state includes only the selected TCI state.

4. The method of claim 1, wherein:
the at least one activated TCI state includes a plurality of activated TCI states;
the first indication comprises a Medium Access Control (MAC) Control Element (CE); and
the method further comprises: receiving, from the cellular network, a second indication of respective TCI states of the plurality of activated TCI states for respective candidate secondary cells of the list of candidate secondary cells; and
the selected TCI state is indicated by the second indication for the selected secondary cell.

5. The method of claim 4, wherein the second indication is provided by radio resource control (RRC) signaling.

6. The method of claim 1, wherein:
the at least one activated TCI state includes a plurality of activated TCI states;
the first indication comprises a first Medium Access Control (MAC) Control Element (CE);
the CSC signal comprises a second MAC-CE; and
the second MAC-CE comprises, for at least one respective candidate secondary cell of the list of candidate secondary cells, a respective indication of whether a respective information block for the respective candidate secondary cell is included in the second MAC-CE, wherein the respective information block comprises an indication of a selected TCI state for the respective candidate secondary cell.

7. The method of claim 6, wherein the respective information block in the second MAC-CE comprises an indication of a timing advance command for the respective candidate secondary cell.

8. The method of claim 1, wherein:
the at least one activated TCI state includes a plurality of activated TCI states;
the first indication comprises a first Medium Access Control (MAC) Control Element (CE); and
the method further comprises:
receiving, from the cellular network, a second indication of one or more cell group lists, wherein each cell group list comprises one or more candidate secondary cells;
receiving, from the cellular network, a third indication of a first TCI state of the plurality of activated TCI states for a first cell group list; and
applying the first TCI state to all cells of the first cell group list.

9. The method of claim 8, wherein:
at least one of the one of more cell group lists comprises a candidate primary cell.

10. The method of claim 8, wherein the first TCI state is the selected TCI state.

11. A method, comprising:
performing, at least one measurement of one or more candidate cell of a cellular network, wherein the at least one measurement comprises a layer 1 (L1) or a layer 2 (L2) measurement;
reporting the at least one measurement of the one or more candidate cell to the cellular network;
receiving, from the cellular network, a first indication of a plurality of activated transmission configuration indication (TCI) states for at least one candidate cell; and
after receiving the first indication, receiving, from the cellular network, a cell switch command (CSC) signal comprising a second indication of a selected TCI state from the plurality of activated TCI states, to use after a cell switch; and
after the cell switch:
applying the selected TCI state to a first candidate cell indicated by the CSC signal; and
releasing at least one other activated TCI state of the plurality of activated TCI states.

12. The method of claim 11, wherein the CSC signal comprises a Medium Access Control (MAC) Control Element (CE).

13. The method of claim 11, wherein said releasing at least one other activated TCI state comprises releasing the TCI states of the plurality of activated TCI states except the selected TCI state.

14. The method of claim 11, further comprising receiving, from the cellular network, a third indication that indicates for which candidate cell the plurality of activated TCI states are to be released by the UE.

15. The method of claim 14, wherein the third indication comprises Radio Resource Control (RRC) signaling.

16. The method of claim 11, wherein said releasing at least one other activated TCI state comprises a candidate cell dependent TCI state release.

17. The method of claim 16, wherein a condition of the candidate cell dependent TCI state release comprises that a TCI state associated with a candidate cell that becomes a serving cell is not released.

18. The method of claim 17, further comprising receiving two TCI state lists for a candidate cell from the cellular network.

19. The method of claim 18, wherein a first TCI state list of the two TCI state lists is a subset of or the same as a second TCI state list of the two TCI state lists.

20. The method of claim 18, further comprising concatenating the two TCI state lists to create a concatenated TCI state list after the cell switch.

21. The method of claim 20, further comprising receiving, from the cellular network, a third indication activating at least one of the plurality of TCI states in the concatenated TCI-state list.

22. The method of claim 21, wherein the third indication comprises a unified TCI states activation/deactivation MAC-CE.

23. The method of claim 21, wherein the third indication refers to the concatenated TCI state list.

24. The method of claim 16, wherein a condition of the candidate cell dependent TCI state release comprises that a TCI state associated with a candidate cell that remains a candidate cell after the cell switch is not released.

25. A method, comprising:
performing, at least one measurement of one or more candidate cell of a cellular network, wherein the at least one measurement comprises a layer 1 (L1) or a layer 2 (L2) measurement;
reporting the at least one measurement of the one or more candidate cell to the cellular network;
receiving, from the cellular network, a first indication of a plurality of activated transmission configuration indication (TCI) states for at least one candidate cell;
after receiving the first indication, receiving, from the cellular network, a cell switch command (CSC) signal comprising an indication of a selected TCI state, of the plurality of activated TCI states, to use following a cell switch; and
after the cell switch:
selecting a first uplink resource for transmission of a message indicating that the cell switch operation is complete; and
transmitting, to the cellular network, the message on the first uplink resource.

26. The method of claim 25, wherein said selecting the first uplink resource is based on a relation of the selected TCI state and uplink resources.

27. The method of claim 25, wherein said selecting the first uplink resource comprises:
determining a first synchronization signal block (SSB) that is configured as quasi co-location (QCL) source RS for the selected TCI; and
selecting an earliest configured grant (CG) physical uplink shared channel (PUSCH) (CG-PUSCH) associated with the first SSB.

28. The method of claim 25, wherein:
the first uplink resource comprises an earliest configured grant (CG) physical uplink shared channel (PUSCH) (CG-PUSCH) after the cell switch; and
the selected TCI state is used for transmitting the first uplink resource transmission.

29. The method of claim 25, wherein said selecting the first uplink resource comprises:
monitoring for dynamic grants after the cell switch, wherein the first uplink resource is scheduled by a dynamic grant signal.

30. The method of claim 29, wherein said monitoring is of a configured search space set for a target cell of the cell switch.

31. An apparatus, comprising a processor configured to cause a user equipment to perform a method according to any of claims 1-30.

32. The apparatus of claim 31, further comprising a radio communicatively coupled to the processor.

33. A baseband processor configured to perform a method according to any of claims 1-30.

34. A non-transitory computer readable memory medium comprising program instructions, the program instructions configured to cause execution of a method according to any of claims 1-30.

35. A method, comprising:
transmitting, to a user equipment (UE), a list of candidate secondary cells;
receiving, from the UE, reporting of at least one measurement of one or more candidate secondary cell of the list of candidate secondary cells, wherein the at least one measurement comprises a layer 1 (L1) or layer 2 (L2) measurement;
transmitting, to the UE, a first indication of at least one activated transmission configuration indication (TCI) state for at least one candidate secondary cell of the list of candidate secondary cells;
after transmitting the first indication, transmitting, to the UE, a cell switch command (CSC) signal to switch from a previous secondary cell to a selected secondary cell of the list of candidate secondary cells; and
applying a selected TCI state for communication between the UE and the selected secondary cell, wherein the selected TCI state is among the at least one activated TCI state.

36. The method of claim 35, wherein the list of candidate secondary cells is configured by an LTMCandidateToAddModList Information Element (IE) in Radio Resource Control (RRC) signaling.

37. The method of claim 35, wherein the at least one activated TCI state includes only the selected TCI state.

38. The method of claim 35, wherein:
the at least one activated TCI state includes a plurality of activated TCI states;
the first indication comprises a Medium Access Control (MAC) Control Element (CE); and
the method further comprises: transmitting, to the UE, a second indication of respective TCI states of the plurality of activated TCI states for respective candidate secondary cells of the list of candidate secondary cells; and
the selected TCI state is indicated by the second indication for the selected secondary cell.

39. The method of claim 38, wherein the second indication is provided by radio resource control (RRC) signaling.

40. The method of claim 35, wherein:
the at least one activated TCI state includes a plurality of activated TCI states;
the first indication comprises a first Medium Access Control (MAC) Control Element (CE);
the CSC signal comprises a second MAC-CE; and
the second MAC-CE comprises, for at least one respective candidate secondary cell of the list of candidate secondary cells, a respective indication of whether a respective information block for the respective candidate secondary cell is included in the second MAC-CE, wherein the respective information block comprises an indication of a selected TCI state for the respective candidate secondary cell.

41. The method of claim 40, wherein the respective information block in the second MAC-CE comprises an indication of a timing advance command for the respective candidate secondary cell.

42. The method of claim 35, wherein:
the at least one activated TCI state includes a plurality of activated TCI states;
the first indication comprises a first Medium Access Control (MAC) Control Element (CE); and
the method further comprises:
transmitting, to the UE, a second indication of one or more cell group lists, wherein each cell group list comprises one or more candidate secondary cells;
transmitting, to the UE, a third indication of a first TCI state of the plurality of activated TCI states for a first cell group list; and
applying the first TCI state to all cells of the first cell group list.

43. The method of claim 42, wherein:
at least one of the one of more cell group lists comprises a candidate primary cell.

44. The method of claim 42, wherein the first TCI state is the selected TCI state.

45. A method, comprising:
receiving, from a user equipment (UE), reporting of at least one measurement of one or more candidate cell of a cellular network, wherein the at least one measurement comprises a layer 1 (L1) or a layer 2 (L2) measurement;
transmitting, to the UE, a first indication of a plurality of activated transmission configuration indication (TCI) states for at least one candidate cell; and
after transmitting the first indication, transmitting, to the UE, a cell switch command (CSC) signal comprising a second indication of a selected TCI state from the plurality of activated TCI states, to use after a cell switch; and
after the cell switch:
applying the selected TCI state for communication between the UE and a first candidate cell indicated by the CSC signal; and
determining that the UE is permitted to release at least one other activated TCI state of the plurality of activated TCI states.

46. The method of claim 45, wherein the CSC signal comprises a Medium Access Control (MAC) Control Element (CE).

47. The method of claim 45, wherein to release at least one other activated TCI state comprises releasing the TCI states of the plurality of activated TCI states except the selected TCI state.

48. The method of claim 45, further comprising transmitting, to the UE, a third indication that indicates for which candidate cell the plurality of activated TCI states are to be released by the UE.

49. The method of claim 48, wherein the third indication comprises Radio Resource Control (RRC) signaling.

50. The method of claim 45, wherein to release at least one other activated TCI state comprises a candidate cell dependent TCI state release.

51. The method of claim 50, wherein a condition of the candidate cell dependent TCI state release comprises that a TCI state associated with a candidate cell that becomes a serving cell is not released.

52. The method of claim 51, further comprising transmitting, to the UE, two TCI state lists for a candidate cell.

53. The method of claim 52, wherein a first TCI state list of the two TCI state lists is a subset of or the same as a second TCI state list of the two TCI state lists.

54. The method of claim 52, further comprising concatenating the two TCI state lists to create a concatenated TCI state list after the cell switch.

55. The method of claim 54, further comprising transmitting, to the UE, a third indication activating at least one of the plurality of TCI states in the concatenated TCI-state list.

56. The method of claim 55, wherein the third indication comprises a unified TCI states activation/deactivation MAC-CE.

57. The method of claim 55, wherein the third indication refers to the concatenated TCI state list.

58. The method of claim 45, wherein a condition of the candidate cell dependent TCI state release comprises that a TCI state associated with a candidate cell that remains a candidate cell after the cell switch is not released.

59. A method, comprising:
receiving, from a user equipment (UE), reporting of at least one measurement of one or more candidate cell of a cellular network, wherein the at least one measurement comprises a layer 1 (L1) or a layer 2 (L2) measurement;
transmitting, to the UE, a first indication of a plurality of activated transmission configuration indication (TCI) states for at least one candidate cell;
after transmitting the first indication, transmitting, to the UE, a cell switch command (CSC) signal comprising an indication of a selected TCI state, of the plurality of activated TCI states, to use following a cell switch; and
after the cell switch:
determining a first uplink resource for reception of a message indicating that the cell switch operation is complete; and
receiving, from the UE, the message on the first uplink resource.

60. The method of claim 59, wherein said determining the first uplink resource is based on a relation of the selected TCI state and uplink resources.

61. The method of claim 59, wherein said determining the first uplink resource comprises:
determining a first synchronization signal block (SSB) that is configured as quasi co-location (QCL) source RS for the selected TCI; and
determining an earliest configured grant (CG) physical uplink shared channel (PUSCH) (CG-PUSCH) associated with the first SSB.

62. The method of claim 59, wherein:
the first uplink resource comprises an earliest configured grant (CG) physical uplink shared channel (PUSCH) (CG-PUSCH) after the cell switch; and
the selected TCI state is used for receiving the first uplink resource transmission.

63. The method of claim 59, wherein the first uplink resource is scheduled by a dynamic grant signal.

64. The method of claim 63, wherein the dynamic grant is transmitted in a configured search space set for a target cell of the cell switch.

65. An apparatus, comprising a processor configured to cause a cellular to perform a method according to any of claims 35-64.

66. A base station, comprising:
a radio; and
a processor, wherein the radio and the processor are configured to perform a method according to any of claims 35-64.

67. A non-transitory computer readable memory medium comprising program instructions, the program instructions configured to cause execution of a method according to any of claims 35-64.
